(19) United States
(12) Patent Application Publication
(10) Pub. No.: US 2016/0055382 A1
(43) Pub. Date: Feb. 25, 2016

(54) VEHICLE DISCRIMINATION APPARATUS

(71) Applicant: KABUSHIKI KAISHA TOSHIBA, Tokyo (JP)

(72) Inventors: Masahiro HORIE, Tokyo (JP); Toshio SATO, Kanagawa-ken (JP); Yasuhiro AOKI, Kanagawa-ken (JP); Yoshihiko SUZUKI, Tokyo (JP); Kenji KIMIYAMA, Kanagawa-ken (JP); Yusuke TAKAHASHI, Tokyo (JP); Junichi NAKAMURA, Kanagawa-ken (JP); Masahiro YAMAMOTO, Tokyo (JP)

(21) Appl. No.: 14/932,400

(22) Filed: Nov. 4, 2015

Related U.S. Application Data
(63) Continuation of application No. PCT/JP2013/007421, filed on Dec. 17, 2013.

(30) Foreign Application Priority Data
May 7, 2013 (JP) 2013-097816

(51) Int. Cl. G06K 9/00

(52) U.S. Cl. CPC G06K 9/00791; G06K 9/00805

(57) ABSTRACT

A vehicle discrimination apparatus specifies a vehicle area in which a vehicle is photographed from an image including the vehicle and discriminates a vehicle passing through a road based on an image which a photographing device such as a camera installed at a side of the road or above the road photographs. The vehicle discrimination apparatus includes an image acquisition section, a first search window setting section, a feature amount calculation section, a likelihood calculation section, a vehicle area determination section, a template creation section, a template storage section, a tracking area setting section, a second search window setting section, a candidate area determination section, a selection section, and a detection section.

### CROSS-REFERENCE TO RELATED APPLICATION

This application is based upon and claims the benefit of priority from the prior Japanese Patent Application No. 2013-097816, filed on May 7, 2013; the entire contents of which are incorporated herein by reference.

### FIELD

Embodiments of the present invention relate to a vehicle discrimination apparatus.

### BACKGROUND

A vehicle discrimination apparatus receives an image of a portion on a road from a camera installed at a side of the road, above the road, or the like, and discriminates a vehicle running on the road. The vehicle discrimination apparatus uses a plurality of vehicle discrimination methods together, to improve accuracy of the vehicle discrimination.

A vehicle discrimination apparatus has a problem that it uses together a plurality of vehicle discrimination apparatuses, and thereby a processing cost increases.

### BRIEF DESCRIPTION OF THE DRAWINGS

FIG. 1A is a block diagram showing a function of a vehicle discrimination apparatus according to an embodiment.

FIG. 1B is a block diagram showing a part of the function of the vehicle discrimination apparatus according to the embodiment.

FIG. 1C is a block diagram showing a part of the function of the vehicle discrimination apparatus according to the embodiment.

FIG. 1D is a block diagram showing a part of the function of the vehicle discrimination apparatus according to the embodiment.

FIG. 2 is a diagram for explaining an example of raster scan according to the embodiment.

FIG. 3 is a diagram showing an example of vehicles which the vehicle detection section according to the embodiment has detected.

FIG. 4 is a diagram showing an example of a template which the template creation section according to the embodiment has created.

FIG. 5 is a diagram showing an example of a tracking area which the tracking area control section according to the embodiment has set.

FIG. 6 is a diagram showing an example of vehicles which the vehicle tracking section according to the embodiment has detected.

FIG. 7 is a diagram showing an example of a vehicle area which the vehicle area selection section according to the embodiment has selected.

FIG. 8 is a flow chart for explaining operation of the vehicle detection section according to the embodiment.

FIG. 9 is a flow chart for explaining operation of the vehicle tracking section according to the embodiment.

FIG. 10 is a flow chart for explaining operation of the template update section according to the embodiment.

FIG. 11 is a top view of a free flow toll fare collection apparatus in which the vehicle discrimination apparatus according to the embodiment is installed.

FIG. 12 is a side view of the free flow toll fare collection apparatus in which the vehicle discrimination apparatus according to the embodiment is installed.

FIG. 13 is a perspective view of the free flow toll fare collection apparatus in which the vehicle discrimination apparatus according to the embodiment is installed.

### DETAILED DESCRIPTION

According to an embodiment, a vehicle discrimination apparatus includes an image acquisition section, a first search window setting section, a feature amount calculation section, a likelihood calculation section, a vehicle area determination section, a template creation section, a template storage section, a tracking area setting section, a second search window setting section, a candidate area determination section, a selection section, and a detection section. The image acquisition section acquires an image. The first search window setting section sets a first search window in the image. The feature amount calculation section calculates a feature amount of the image in the first search window. The likelihood calculation section calculates a likelihood indicating a possibility that the image in the first search window is a first vehicle area including a vehicle image, based on the feature amount. The vehicle area determination section determines whether the image in the first search window is the first vehicle area, based on the likelihood. The template creation section generates a template image based on the first vehicle area. The template storage section stores the template image. The tracking area setting section sets a tracking area based on the template image. The second search window setting section sets a second search window in the tracking area. The candidate area determination section determines whether an image in the second search window is a candidate area that is an area to coincide with the template image. The selection section selects a second vehicle area including the vehicle which the template image indicates from the candidate area. The detection section detects at least presence/absence of the vehicle based on the first vehicle area and the second vehicle area.

### Embodiments

A vehicle discrimination apparatus according to an embodiment specifies an area (a vehicle area) in which a vehicle is photographed from an image including the vehicle. The vehicle discrimination apparatus discriminates a vehicle passing through a road based on an image which a photographing device such as a camera installed at a side of the road or above the road photographs.

Hereinafter, a vehicle discrimination apparatus according to an embodiment will be described with reference to the drawings.

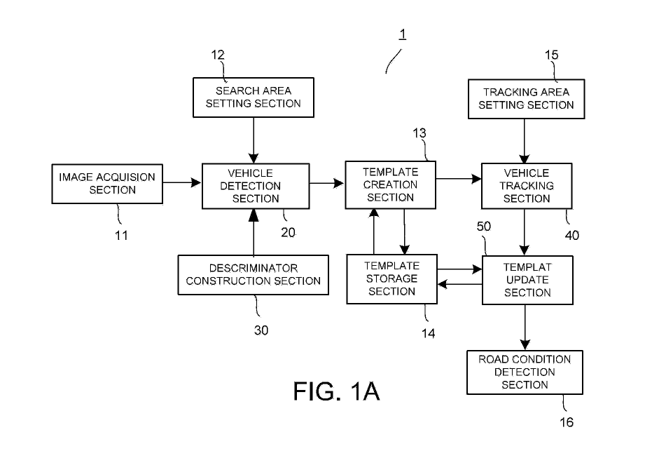

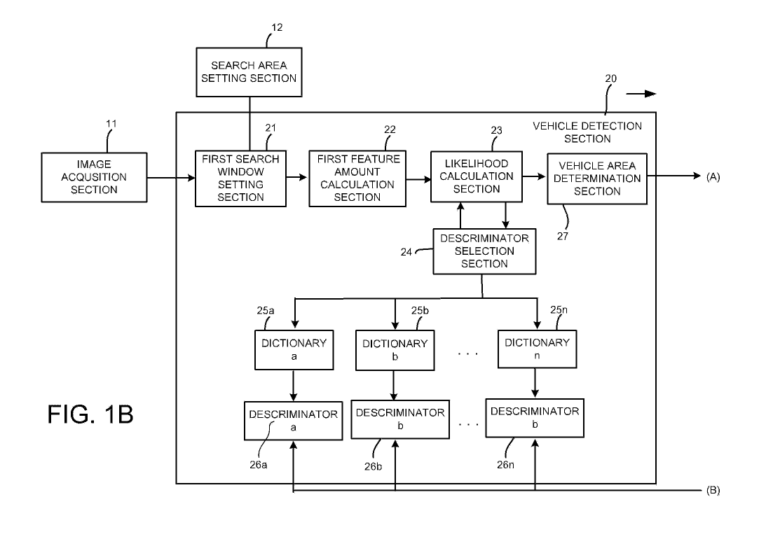

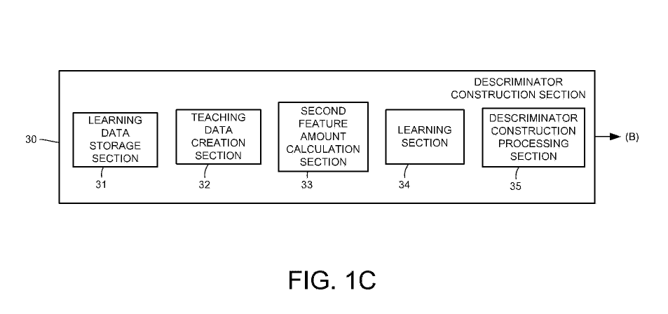

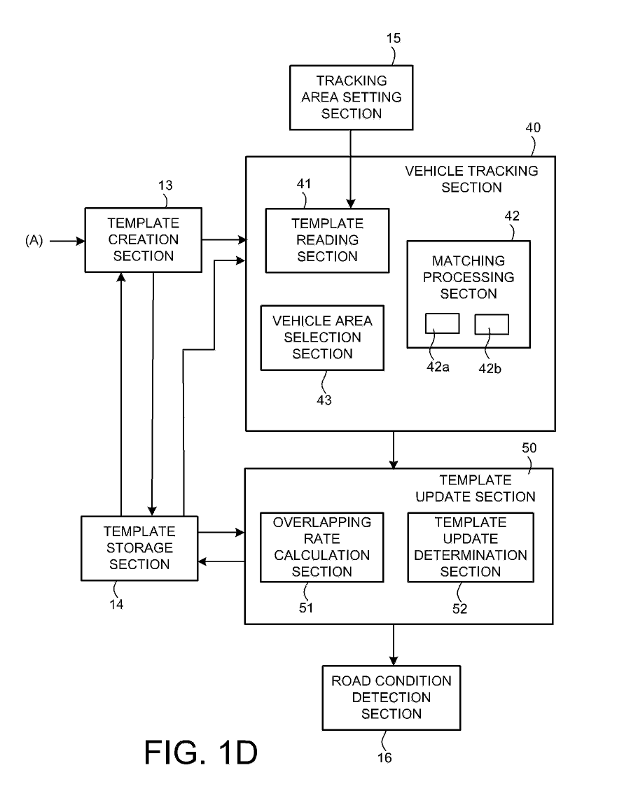

FIG. 1A is a block diagram showing a function of a vehicle discrimination apparatus 1 according to an embodiment. FIG. 1B particularly shows the details of a vehicle detection section 20. FIG. 1C shows the details of a discriminator construction section 30. FIG. 1D particularly shows a vehicle tracking section 40 and the details of a template update section 50.

As FIG. 1A shows, the vehicle discrimination apparatus 1 has an image acquisition section 11, a search area setting section 12, a template creation section 13, a template storage section 14, a tracking area setting section 15, a road condition detection section 16, the vehicle detection section 20, the discriminator construction section 30, the vehicle tracking section 40 and the template update section 50.

The image acquisition section 11 acquires an image including an image of a road. The image acquisition section 11 is connected to a photographing device such as a camera. The photographing device is an ITV camera or the like. The photographing device is installed at a side of a road or above the road, and photographs the road. The image acquisition section 11 continuously acquires the images which the photographing device has photographed. When a vehicle exists on a road, the image includes an image of the vehicle.

The image acquisition section 11 transmits the acquired images for each frame to the vehicle detection section 20.

The search area setting section 12 sets a search area in which the vehicle detection section 20 searches for a vehicle to the vehicle detection section 20. That is, the search area setting section 12 sets a search area to a frame (frame image) which the image acquisition section 11 transmits. The search area setting section 12 sets an image area where a vehicle can exist to the frame image, as the search area. The image area where a vehicle can exist is an area (road area) where a road is photographed, or the like. In this case, a search area may be previously designated to the search area setting section 12 by an operator. In addition, the search area setting section 12 may specify a road area using pattern analysis or the like, and may set the road area as the search area.

The method in which the search area setting section 12 determines a search area is not limited to a specified method.

In addition, the search area setting section 12 sets a size of a first search window in which the vehicle detection section 20 scans the search area to the vehicle detection section 20. That is, the search area setting section 12 determines a size of an object area (first search window) in which a likelihood indicating a possibility to be a vehicle area is calculated. The search area setting section 12 changes a size of the first search window within the search area. For example, the search area setting section 12 determines a size of the first search window, based on the distance between an object photographed in the image and the photographing device. For example, the search area setting section 12 sets a relatively small first search window for a distant area from the photographing device, and sets a relatively large first search window for an area near from the photographing device.

The search area setting section 12 transmits coordinates indicating the search area (upper left coordinates and lower right coordinates of the search area, for example) and information indicating the size of the first search window, to the vehicle detection section 20.

Next, the vehicle detection section 20 will be described. The vehicle detection section 20 extracts a vehicle area in a frame image.

As FIG. 1B shows, the vehicle detection section 20 is provided with a first search window setting section 21, a first feature amount calculation section 22, a likelihood calculation section 23, a discriminator selection section 24, dictionaries 25a to 25n, discriminators 26a to 26n, and a vehicle area determination section 27 and so on.

The first search window setting section 21 sets a first search window to the frame image from the image acquisition section 11, based on the information from the search area setting section 12. That is, the first search window setting section 12 sets a first search window with a size which the search area setting section 12 sets, in the search area which the search area setting section 12 sets.

The first search window setting section 21 sets a first search window in each portion within the search area. For example, the first search window setting section 21 may set a plurality of first search windows in the search area with prescribed dot intervals in an x-coordinate direction and a y-coordinate direction.

The first feature amount calculation section 22 calculates a feature amount of an image in the first search window which the first search window setting section 21 has set. The feature amount which the first feature amount calculation section 22 calculates is a feature amount which the likelihood calculation section 23 uses for calculating a likelihood. For example, the feature amount which the first feature amount calculation section 22 calculates is a CoHOG (Co-occurrence Histograms of Gradients) feature amount, or a HOG (Histograms of Gradients) feature amount, or the like. In addition, the first feature amount calculation section 22 may calculate plural kinds of feature amounts. The feature amount which the first feature amount calculation section 22 calculates is not limited to the specific configuration.

The likelihood calculation section 23 calculates a likelihood indicating a possibility that an image in the first search window is a first vehicle area including an image of a vehicle, based on the feature amount which the first feature amount calculation section 22 has calculated. The likelihood calculation section 23 calculates a likelihood using at least one of the discriminators 26a to 26n. In calculating the likelihood, the likelihood calculation section 23 uses the discriminator 26 which the discriminator selection section 24 selects. The discriminator 26 stores an average value, a dispersion and so on of feature amounts of a vehicle image. In this case, the likelihood calculation section 23 may compare the average value and dispersion of the feature amounts of the vehicle image which the discriminator 26 stores, with a feature amount of an image within the first search window, to calculate the likelihood. The method in which the likelihood calculation section 23 calculates a likelihood is not limited to a specific method.

The discriminator selection section 24 selects the discriminator 26 which the likelihood calculation section 23 uses for calculating the likelihood. That is, the discriminator selection section 24 selects at least one discriminator 26 out of the discriminators 26a to 26n. For example, the discriminator selection section 24 may select the discriminator 26, by comparing a brightness value and so on which the dictionary 25 corresponding to each discriminator and a brightness value and so on of the image in the first search window. In addition, the discriminator selection section 24 may select the discriminator 26 in accordance with the road conditions. For example, the discriminator selection section 24 may presume a direction of the vehicle from a direction and so on in which the photographing device photographs a road, and may select the discriminator 26 in accordance with the direction of the vehicle. The method in which the discriminator selection section 24 selects the discriminator 26 is not limited to a specific method.

The dictionary 25 stores information (dictionary information) which the discriminator selection section 24 requires for selecting the discriminator 26. The dictionary information which the dictionary 25 stores is information in accordance with the discriminator 26 to which the dictionary 25 corresponds. The dictionaries 25a to 25n correspond to the discriminators 26a to 26n, respectively. For example, the dictionary 25 stores information indicating a brightness value and so on of the vehicle image which the discriminator 26 discriminates, as the dictionary information.

The discriminator 26 stores information (discriminator information) which the likelihood calculation section 23 uses for calculating a likelihood. For example, the discriminator information may be an average value, a dispersion and so on of the feature amounts of the vehicle image. In addition, the discriminators 26 exist by a plurality of numbers depending on a kind, a direction and so on of a vehicle. For example, the discriminators 26 exist by a plurality of numbers, depending on a kind (category) of a vehicle, such as a standard-sized car and a large-sized car, and depending on a direction (category) of a vehicle, such as a forward, a backward and a sideward direction. For example, the discriminator 26a may store the discriminator information for calculating a likelihood of a standard-sized car directing in a forward direction. Here, the discriminators 26a to 26n exist. The number and kind of the discriminators 26 are not limited to the specific configuration.

The vehicle area determination section 27 determines whether the image within the first search window is the first vehicle area, from the likelihood which the likelihood calculation section 23 has calculated. For example, when the likelihood which the likelihood calculation section 23 has calculated is larger than a prescribed threshold value (likelihood threshold value), the vehicle area determination section 27 determines that the image within the first search window is the first vehicle area.

When having determined that the image within the first search window is the first vehicle area, the vehicle area determination section 27 transmits the image within the relevant first search area and the information indicating the upper left coordinates and the lower right coordinates of the relevant first search window to the template creation section 13. That is, the vehicle area determination section 27 transmits the image of the first vehicle area and the coordinates of the first vehicle area (information indicating the first vehicle area) to the template creation section 13. In addition, the vehicle area determination section 27 transmits a frame image to the template creation section 13.

Next, the discriminator construction section 30 will be described. The discriminator construction section 30 constructs the discriminators. As FIG. 1C shows, the discriminator construction section 30 is provided with a learning data storage section 31, a teaching data creation section 32, a second feature amount calculation section 33, a learning section 34 and a discriminator construction processing section 35 and so on.

The learning data storage section 31 previously stores a lot of learning images. The learning image is an image which a camera or the like has photographed, and includes an image of a vehicle.

The teaching data creation section 32 creates a rectangular vehicle area from the learning image which the learning data storage section 31 stores. For example, an operator visually may recognize the learning image, and may input the rectangular vehicle area to the teaching data creation section 32.

The second feature amount calculation section 33 calculates a feature amount of the vehicle area which the teaching data creation section 32 has created. The feature amount which the second feature amount calculation section 33 calculates is a feature amount for generating the discriminator information which the discriminator 26 stores. The feature amount which the second feature amount calculation section 33 calculates is a CoHOG feature amount, a HOG feature amount, or the like. In addition, the second feature amount calculation section 33 may calculate plural kinds of feature amounts. The feature amount which the second feature amount calculation section 33 is not limited to the specific configuration.

The learning section 34 generates learning data in which the feature amount which the second feature amount calculation section 33 calculates and the category (for example, the kind of the vehicle and the direction of the vehicle) of the vehicle image from which the feature amount has been calculated are associated with each other.

The discriminator construction processing section 35 generates discriminator information which each discriminator 26 stores, based on the learning data which the learning section 34 has generated. For example, the discriminator construction processing section 35 classifies the learning data by category, and creates discriminator information based on the classified learning data. For example, the discriminator construction processing section 35 may use a method of non-rule base which constructs a discrimination parameter, by machine learning such as a subspace method, a support vector machine, a K vicinity discriminator, Bays classification. The method in which the discriminator construction processing section 35 generates the discriminator information is not limited to a specific method.

The discriminator construction section 30 stores the discriminator information which the discriminator construction processing section 35 has generated into the respective discriminators 26a to 26n.

The template creation section 13 transmits the frame image received from the vehicle detection section 20 (the vehicle area determination section 27) to the vehicle tracking section 40. In addition, the template creation section 13 generates a template image, based on the coordinates of the first vehicle area (information indicating the first vehicle area), and the image of the first vehicle area which have been received from the vehicle detection section 20 (the vehicle area determination section 27). The template image is a vehicle image included in the first vehicle area which is extracted from the frame image. The template creation section 13 generates a template image to each first vehicle area which the vehicle detection section 20 has detected. In addition, a size of the template image may be the same as the first search window, or may be smaller than the first search window by deleting the background, by several bits.

In addition, the template creation section 13 may receive the information indicating the first vehicle area once for several frame images, and may generate a template image based on the received data. That is, the template creation section 13 may receive the information indicating the first vehicle area from the vehicle area determination section 27 for each several images, and may generate a template image based on the received data. In this case, the vehicle discrimination apparatus 1 may change an interval of the number of frames when the template creation section 13 generates the template image, in accordance with the road conditions such as the number of vehicles on a road, the speeds of the vehicles and the presence/absence of an accident.

The template creation section 13 stores the generated template image and the information indicating the upper left coordinates and the lower right coordinates of the template image in the template storage section 14.

The template storage section 14 stores the information indicating the upper left coordinates and the lower right coordinates of the template image which the template creation section 13 has created, and the template image.

The tracking area setting section 15 sets a tracking area in which the vehicle tacking section 40 searches a second vehicle area in the frame image. The tracking area setting section 15 sets a tracking area to each area which the template image shows. The tracking area setting section 15 sets a tracking area to each area which the template image shows and its periphery. For example, the tracking area setting section 15 determines a size of the tracking section based on the distance between an object photographed in the image and the photographing device. For example, the tracking area setting section 15 sets a small tracking area around the vehicle area regarding an area distant from the photographing device, and sets a large tracking area around the vehicle area regarding an area near from the photographing device. Generally, as the y-coordinate becomes smaller in the frame image, the vehicle area becomes linearly smaller. For the reason, the tracking area setting section 15 may make the size of the tracking area linearly smaller, as the y-coordinate becomes smaller.

In addition, the tracking area setting section 15 may set the tracking area in accordance with the likelihood of the first vehicle area. For example, when the likelihood of the first vehicle area is small (that is, the likelihood is smaller than a likelihood threshold value), the template image does not properly include the actual vehicle image, and is deviated from the vehicle image. In this case, the tracking area setting section 15 sets a relatively large tracking area. In addition, when the likelihood of the first vehicle area is large (that is, the likelihood greatly exceeds the likelihood threshold value), the template image properly includes the actual vehicle image. In this case, the tracking area setting section 15 sets a relatively small tracking area. The method in which the tracking area setting section 15 determines a size of the tracking area is not limited to a specific method.

The tracking area setting section 15 transmits the information indicating the upper left coordinates and the lower right coordinates of the tracking area to the vehicle tracking section 40.

Next, the vehicle tracking section 40 will be described. As FIG. 1D shows, the vehicle tracking section 40 is provided with a template reading section 41, a matching processing section 42, a vehicle area selection section 43, and so on.

The vehicle tracking section 40 extracts a second vehicle area from the frame image, based on the template image which is based on the previous frame image. The second vehicle area is an area including a vehicle which the template image shows. For example, the vehicle tracking section 40 extracts the second vehicle area from the frame image at a time t, using the template image based on the frame image at a time t-1 (that is, a time at one frame time before a time when the image acquisition section 11 has acquired the present frame image). That is, the vehicle tracking section 40 extracts the second vehicle area from the frame image which has been photographed later than the frame image used for creation of the template image.

The template reading section 41 acquires the template image which the template storage section 14 stores, and the upper left coordinates and the lower right coordinates of the tracking area which the tracking area setting section 15 has set, and so on.

The matching processing section 42 extracts a candidate area which matches the template image in the tracking area. The matching processing section 42 is provided with a second search window setting section 42a, a candidate area determination section 42b, and so on.

The matching processing section 42 performs raster scan using the template image or the like in the tracking area. In the raster scan, the search window moves from the upper left of the tracking area to the right by a prescribed number of dots. When the search window moves to the right end, the search window moves down by a prescribed number of dots, and returns to the left end. The search window moves to the right again. In the raster scan, the search window repeats the above-describe movement until the search window reaches the lower right end.

The second search window setting section 42a sets a second search window in the tracking area. Since the matching processing section 42 performs the raster scan, the second search window setting section 42a moves the second search window as described above.

The second search window setting section 42a determines a size of the second search window based on the template image. The size of the second search window may be the same as the template image, or may be smaller than the template image by deleting the background, by several bits.

The candidate area determination section 42b of the matching processing section 42 determines whether the image in the second search window is the candidate area which matches the template image. Here, the template image is a template image corresponding to the tracking area in which the second search window is installed. For example, the candidate area determination section 42b calculates the difference between a brightness value of each dot in the second search window and a brightness value of each dot in the template image, and calculates a value (sum total value) obtained by adding the all differences of the brightness values of the respective dots. When having calculated the sum total value, the candidate area determination section 42b determines whether the sum total value is not more than a prescribed threshold value (brightness threshold value). When the sum total value is not more than the brightness threshold value, the candidate area determination section 42b determines that the image in the relevant second search window is the candidate area. When the sum total value is more than the brightness threshold value, the candidate area determination section 42b determines that the image in the relevant second search window is not the candidate area. In addition, the candidate area determination section 42b may compare the image in the second search window with the template image with pattern matching or the like, and may determine whether the image in the relevant second search window is the candidate area. The method in which the candidate area determination section 42b determines whether the image in the relevant second search window is the candidate area is not limited to a specific method.

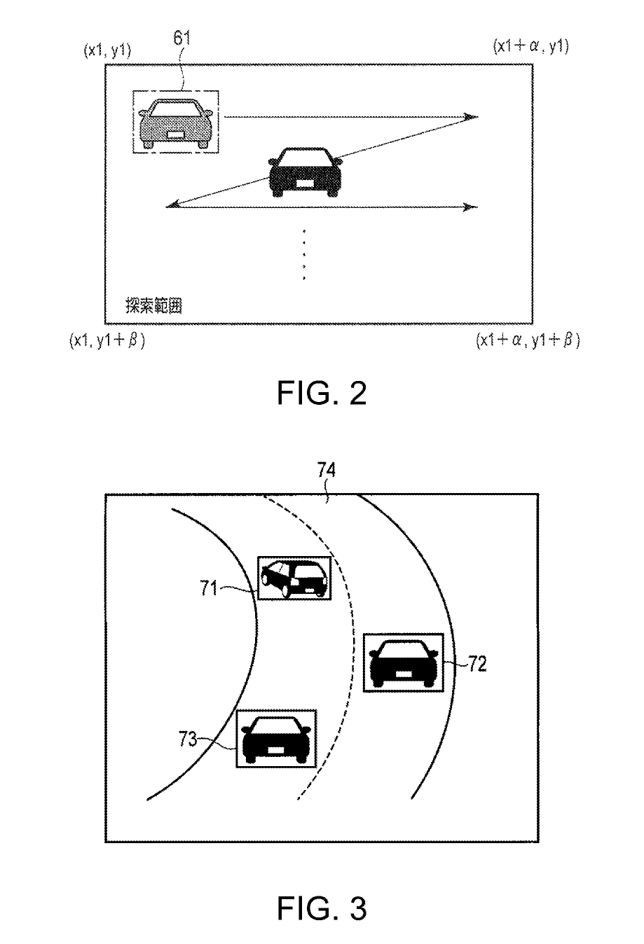

FIG. 2 is a diagram for explaining the raster scan which the matching processing section 42 performs.

In an example which FIG. 2 shows, it is assumed that the tracking area setting section 15 sets (x1, y1) as the upper left coordinates of the tracking area, and (x1+α, y1+β) as the lower right coordinates thereof in the frame image.

To begin with, the second search window setting section 42a of the matching processing section 42 sets a second search window 61 at an upper left portion in the tracking area. When the second search window setting section 42a sets the second search window 61 at the upper left portion in the tracking area, the candidate area determination section 42b calculates a sum total value, based on the difference between the brightness value of each dot of the template image and the brightness value of each dot in the second search window. When the candidate area determination section 42b calculates the sum total value, the candidate area determination section 42b determines whether the image in the second search window is a candidate area from the sum total value. When the candidate area determination section 42b determines that the image in the second search window is the candidate area, the second search window setting section 42a sets the next second search window 61.

As FIG. 2 shows, the second search window 61 moves from the left end to the right end by each prescribed number of dots. Having moved to the right end, the second search window 61 returns to the left end, and moves downward by a prescribed number of dots. The second search window 61 repeats the above-described movement, and moves to the lower left end of the tracking area.

when the second search window 61 moves to the lower right end of the tracking area, the matching processing section 42 finishes the tracking processing.

The vehicle area selection section 43 selects a second vehicle area including the vehicle which the template image shows, from the candidate areas which the matching processing section 42 has extracted. When the candidate area which the matching processing section 42 has extracted is one, the vehicle area selection section 43 selects the relevant candidate area as the second vehicle area.

When the candidate areas which the matching processing section 42 has extracted is two or more, the vehicle area selection section 43 selects one candidate area from a plurality of the candidate areas, as the second vehicle area. For example, the vehicle area selection section 43 selects the candidate area based on the past second vehicle area. The vehicle area selection section 43 may presume a running direction of the vehicle from the position of the past vehicle area, and may select the candidate area on the extension line in the presumed running direction. When a road curves, the vehicle area selection section 43 may presume a running direction along the curve of the road. In addition, when a road is straight, the vehicle area selection section 43 may presume a straight running direction. The method in which the vehicle area selection section 43 selects the candidate area is not limited to a specific method.

When the vehicle area selection section 43 selects the candidate area as the second vehicle area, the vehicle tracking section 40 transmits the selected second vehicle area to the template update section 50.

In addition, the vehicle tracking section 40 may generate movement information indicating a speed and a movement direction of the vehicle based on the first vehicle area, the second vehicle area, and so on.

Next, the template update section 50 will be described. As FIG. 1D shows, the template update section 50 is provided with an overlapping rate calculation section 51, a template update determination section 52, and so on.

The template update section 50 updates the template image which the vehicle tracking section 40 uses for extracting the second vehicle area to a new template image based on the first vehicle area which the vehicle detection section 20 has extracted. For example, when the vehicle tracking section 40 has extracted the second vehicle area from the frame image at a time t, using the template image based on the frame image at a time t-1, the template update section 50 updates the template image which the vehicle tracking section 40 uses for extracting the second vehicle area to the template image based on the frame image at a time t.

The overlapping rate calculation section 51 compares a template image based on a certain frame image with a second vehicle image which the vehicle tracking section 40 has extracted from the same frame image, to calculate an overlapping rate. For example, the vehicle detection section 20 extracts the first vehicle area from the frame image at a time t-1. The template creation section 13 generates the template image from the relevant first vehicle image. The vehicle tracking section 40 extracts the second vehicle area from the frame image at a time t based on the relevant template image. Simultaneously, the vehicle detection section 20 extracts the first vehicle area from the frame image at a time t. The template creation section 13 generates a new template image at a time t from the relevant first vehicle image. The overlapping rate calculation section 51 compares the second vehicle image at a time t with the new template image at the time t, to calculate the overlapping rate.

The overlapping rate is a value indicating the matching degree of the both images. For example, the overlapping rate may be calculated based on a value obtained by summing the differences between brightness values of the respective dots of the both images. In addition, the overlapping rate may be calculated by pattern matching of the both images. The method of calculating the overlapping rate is not limited to a specific method.

The template update determination section 52 determines whether to update the template image based on the overlapping rate which the overlapping rate calculation section 51 has calculated. That is, when the overlapping rate is larger than a prescribed threshold value, the template update determination section 52 updates the template image. In addition, when the overlapping rate is not more than the prescribed threshold value, the template update determination section 52 does not update the template image.

When the template update determination section 52 updates the template image, the template update determination section 52 stores the new template image and the information indicating the upper left coordinates and the lower right coordinates of the new template image in the template storage section 14. In addition, when the template update determination section 52 updates the template image, the tracking area setting section 15 sets the tracking area again in the frame image, based on the updated template image.

The road condition detection section 16 detects presence/absence of a vehicle and the number of vehicles, based on the first vehicle area which the vehicle detection section 20 has extracted, and the second vehicle area which the vehicle tracking section 40 has extracted. For example, the road condition detection section 16 may determine that a vehicle is present in an area where the first vehicle area and the second vehicle area overlap with each other, or may determine that a vehicle is present in an area where any of the first vehicle area or the second vehicle area is present. In addition, the road condition detection section 16 may detect road conditions such as congestion of a road, the number of passing vehicles, excess speed, stop, low speed, avoidance, and reverse run, based on the detection result of a vehicle. For example, the road condition detection section 16 may detect each event from the movement information which the vehicle tracking section 40 has generated.

Next, an operation example of the vehicle discrimination apparatus 1 will be described.

To begin with, the image acquisition section 11 acquires a frame image including a vehicle area from the photographing device. When the image acquisition section 11 acquires the frame image, the image acquisition section 11 transmits the acquired frame image to the vehicle detection section 20.

The vehicle detection section 20 receives the frame image from the image acquisition section 11. When the vehicle detection section 20 acquires the frame image, the search area setting section 12 sets a search area in the frame image. The search area setting section 12 transmits coordinates indicating the search area and information indicating a size of a first search window to the vehicle detection section 20.

when the search area setting section 12 transmits the coordinates indicating the search area and the size of the first search window to the vehicle detection section 20, the vehicle detection section 20 extracts a first vehicle area from the frame image, based on the size of the first search window and the search area. An operation example that the vehicle detection section 20 extracts the first vehicle area will be described later.

FIG. 3 is a diagram showing an example of the first vehicle area which the vehicle detection section 20 has extracted. In the example of FIG. 3, the search area setting section 12 sets a portion on a road 74 to the vehicle detection section 20, as a search area. In addition, in FIG. 3, since the upper portion in the drawing is distant from the photographing device, and the lower portion in the drawing is near from the photographing device, the search area setting section 12 sets a relatively small first search window regarding the upper portion of the road 74, and sets a relatively large first search window regarding the lower portion of the road 74.

The vehicle detection section 20 extracts a first vehicle area, based on the search area and the size of the first search window which the search area setting section 12 has set. As FIG. 3 shows, the vehicle detection section 20 extracts first vehicle areas 71, 72 and 73. Since the search area setting section 12 has set a relatively small first search window regarding the upper portion of the road 74, the first vehicle area 71 is smaller than the first vehicle areas 72 and 73. In the example of FIG. 3, the vehicle detection section 20 has extracted the three first vehicle areas 71 to 73, but the number of the first vehicle areas which the vehicle detection section 20 extracts is not limited to a specific number.

When the vehicle detection section 20 extracts the first vehicle area, the vehicle detection section 20 transmits the image of the first vehicle area and the information of the upper left coordinates and the lower right coordinates of the first vehicle area to the template creation section 13. In the example of FIG. 3, the vehicle detection section 20 transmits the images of the first vehicle areas 71 to 73 and information indicating the upper left coordinates and the lower right coordinates of each image to the template creation section 13.

The template creation section 13 receives the image of the first vehicle area and the information indicating the upper left coordinates and the lower right coordinates of the first vehicle area from the vehicle detection section 20. When the template creation section 13 receives each data, the template creation section 13 generates a template image.

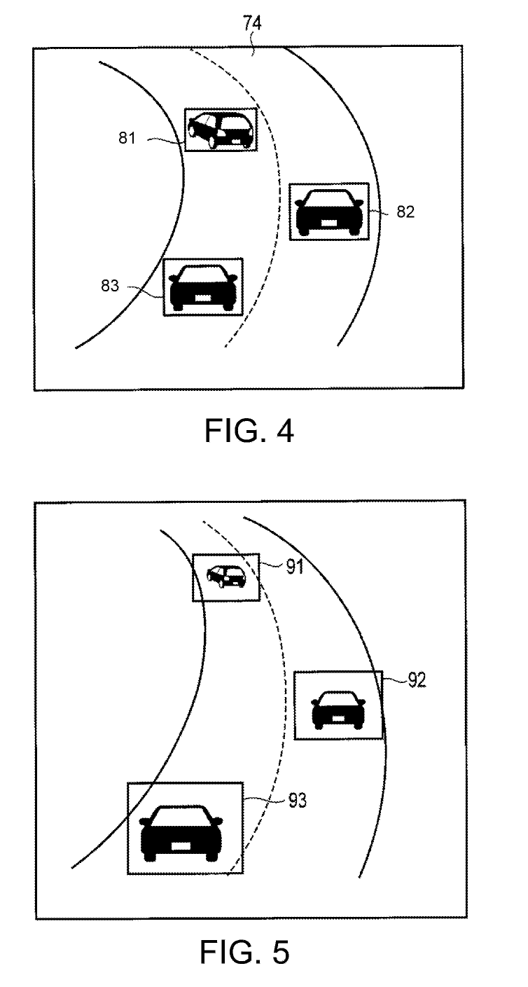

FIG. 4 is an example of a template image which the template creation section 13 has generated. The template image which FIG. 4 shows is generated based on the frame image which FIG. 3 shows.

In the example which FIG. 4 shows, an image 81, an image 82 and an image 83 are template images. The image 81, the image 82 and the image 83 respectively correspond to the vehicle area 71, the vehicle area 72 and the vehicle area 73. That is, the image 81, the image 82 and the image 83 are respectively generated based on the vehicle area 71, the vehicle area 72 and the vehicle area 73.

When the template creation section 13 generates the template image, the template storage section 14 stores the template image which the template creation section 13 has generated and the information (coordinate information) indicating the upper left coordinates and the lower right coordinates of the template image.

When the template storage section 14 stores each data, the tracking area setting section 15 sets a tracking area in the frame image, based on the template image and the coordinate information which the template storage section 14 stores.

FIG. 5 is a diagram showing an example of the tracking area which the tracking area setting section 15 has set to the frame image.

In the example which FIG. 5 shows, a tracking area 91, a tracking area 92 and a tracking area 93 correspond to the image 81, the image 82 and the image 83. That is, the vehicle tracking section 40 extracts the same vehicle as the vehicle which the image 81 shows in the tracking area 91. In addition, the vehicle tracking section 40 extracts the same vehicle as the vehicle which the image 82 shows in the tracking area 92. In addition, the vehicle tracking section 40 extracts the same vehicle as the vehicle which the image 83 shows in the tracking area 93.

As FIG. 5 shows, the tracking area 91 is the smallest, and the tracking area 92 is next small, and the tracking area 93 is the largest. This is because, in the frame image, as the y coordinate becomes smaller (that is, as it goes upper), the object is more distant from the photographing device and is photographed smaller. For the reason, the tracking area setting section 15 sets a relatively small tracking area (the tracking area 91, for example) for the template image (the image 81, for example) with the small y coordinate. Similarly, the tracking area setting section 15 sets a relatively large tracking area (the tracking area 93, for example) for the template image (the image 83, for example) with the large y coordinate.

When the tracking area setting section 15 sets the tracking area to the vehicle tracking section 40, the vehicle tracking section 40 extracts a second vehicle area in the next frame image. For example, when the tracking area is set based on the frame image at a time t-1, the vehicle tracking section 40 extracts a second vehicle area in a frame image at a time t. An operation example that the vehicle tracking section 40 extracts the second vehicle area will be described later.

FIG. 6 is a diagram showing an example of the second vehicle area which the vehicle tracking section 40 has extracted. In the example which FIG. 6 shows, an image 101, an image 102 and an image 103 are template images each of which the vehicle tracking section 40 has used for extracting the second vehicle area.

In addition, in the example which FIG. 6 shows, the vehicle tracking section 40 extracts a second vehicle area 104, a second vehicle area 105 and a second vehicle area 106, based on the image 101, the image 102 and the image 103, respectively.

The second vehicle area 104, the second vehicle area 105 and the second vehicle area 106 respectively correspond to the image 101, the image 102 and the image 103. For example, the vehicle tracking section 40 extracts the second vehicle area 104 including the vehicle which the image 101 indicates. In addition, the vehicle tracking section 40 extracts the second vehicle area 105 including the vehicle which the image 102 indicates. In addition, the vehicle tracking section 40 extracts the second vehicle area 106 including the vehicle which the image 103 indicates

Next, a case in which the matching processing section 42 has extracted a plurality of candidate areas in a tracking area will be described.

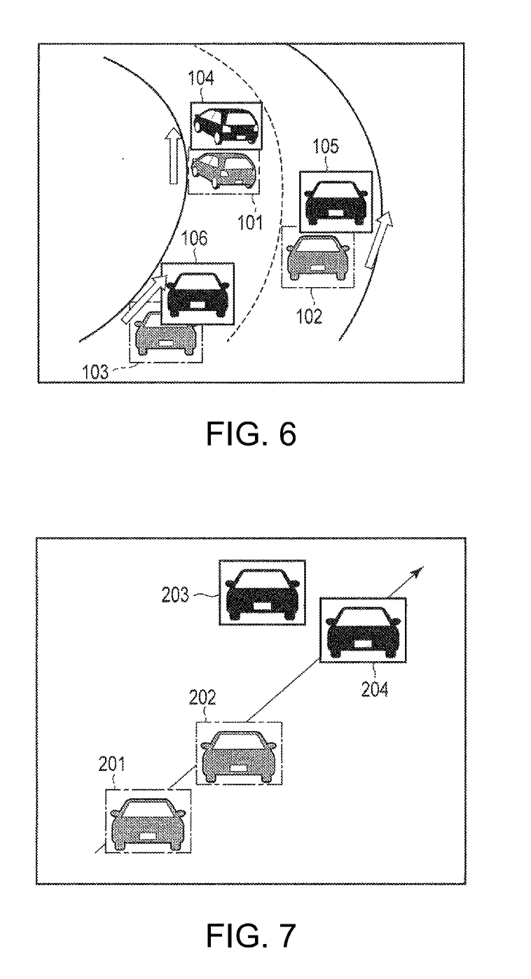

FIG. 7 is a diagram showing an example of a tracking area including a plurality of candidate areas.

As FIG. 7 shows, the matching processing section 42 extracts a candidate area 203 and a candidate area 204 in the candidate area.

In this case, the vehicle area selection section 43 selects a second vehicle area from the past vehicle area. Here, the vehicle area selection section 43 selects the second vehicle area at a time t. In the example which FIG. 7 shows, a vehicle area 201 is a vehicle area at a time t-2. In addition, a vehicle area 202 is a vehicle area at a time t-1.

The vehicle area selection section 43 selects a candidate area on the extension line of the vehicle area 201 and the vehicle area 202, as a second vehicle area. In FIG. 7, on the extension line of the vehicle area 201 and the vehicle area 202, the candidate area 204 exists. For the reason, the vehicle area selection section 43 selects the candidate area 204, as the second vehicle area.

In addition, the vehicle area selection section 43 may select the second vehicle area in accordance with a curve of a road. The method in which the vehicle area selection section 43 selects the second vehicle area is not limited to a specific method.

When the vehicle tracking section 40 extracts the second vehicle area, the template update section 50 determines whether to update the template image, and updates the template image when having determined to update. An operation example that the template update section 50 updates the template image will be described later.

When the template update section 50 finishes the update processing of the template image, the road condition detection section 16 detects presence/absence of vehicle, the number of vehicles, and so on, as described above, based on the first vehicle area which the vehicle detection section 20 has extracted, and the second vehicle area which the vehicle tracking section 40 has extracted. When the road condition detection section 16 detects presence/absence of vehicle, the number of vehicles, and so on, the road condition detection section 16 may detect road conditions based on the detected presence/absence of vehicle, the number of vehicles, and so on. When the road condition detection section 16 detects the road conditions and so on, the vehicle discrimination section 1 finishes its operation.

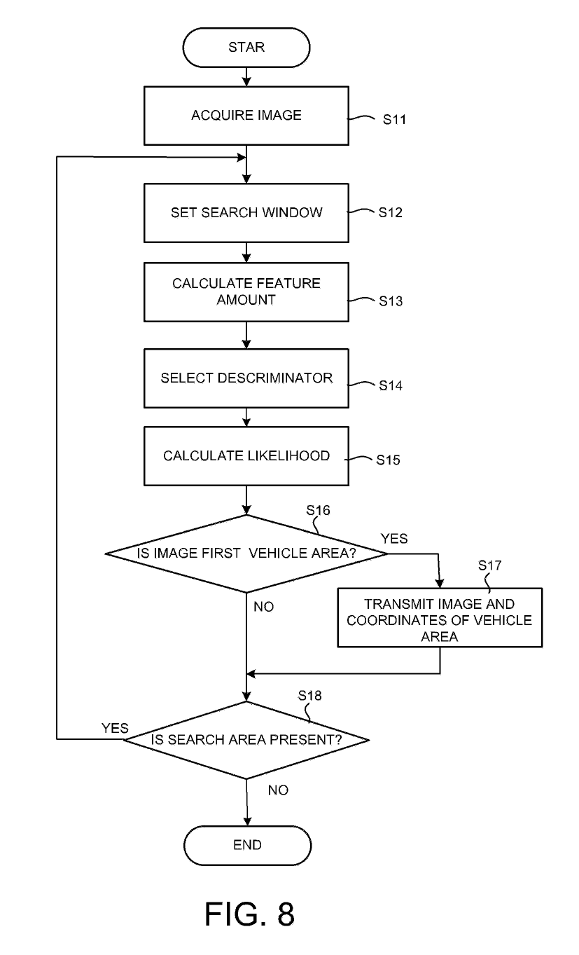

Next, an operation example in which the vehicle detection section 20 extracts a first vehicle area will be described with reference to FIG. 8. FIG. 8 is a flow chart for explaining an operation example in which the vehicle detection section 20 extracts a first vehicle area.

To begin with, the vehicle detection section 20 acquires a frame image from the image acquisition section 11 (step S11).

When the vehicle detection section 20 acquires the frame image, the first search window setting section 21 sets a first search window in a search area of the frame image (step S12). The first search window setting section 21 sets the first search window at a prescribed position in the search area. In addition, in the setting of a first search window at a second and subsequent times, the first search window setting section 21 sets a first search window in an area where the first search window has not been set so far.

When the first search window setting section 21 sets the first search window, the first feature amount calculation section 22 calculates a feature amount based on the image in the first search window (step S13). When the first feature amount calculation section 22 calculates the feature amount, the discriminator selection section 24 selects a discriminator 26 based on the image in the first search window (step S14). When the discriminator selection section 24 selects the discriminator 26, the likelihood calculation section 23 calculates a likelihood of the image in the first search window using the discriminator 26 which the discriminator selection section 24 has selected (step S15).

When the likelihood calculation section 23 calculates the likelihood, the vehicle area determination section 27 determines whether the image in the first search window is the first vehicle area from the likelihood which the likelihood calculation section 23 has calculated (step S16).

When the vehicle area determination section 27 determines that the image in the first search window is the first vehicle area (step S16, YES), the vehicle detection section 20 transmits the image of the first vehicle area which the vehicle area determination 27 has extracted and the information indicating the upper left and the lower right coordinates of the first vehicle area to the template creation section 13 (step S17).

When the vehicle area determination section 27 determines that the image in the first search window is not the first vehicle area (step S16, NO), or when the vehicle detection section 20 has transmitted each data to the template creation section 13 (step S17), the vehicle detection section 20 determines whether the search area where the first search window has not been set is present (step S18).

When the vehicle detection section 20 determines that the search area where the first search window has not been set is present (step S18, YES), the vehicle detection section 20 returns the operation to the step S12. When the vehicle detection section 20 determines that the search area where the first search window has not been set is not present (step S18, NO), the vehicle detection section 20 finishes the operation.

In addition, the vehicle detection section 20 may transmit the image of the first vehicle area and the information indicating the upper left coordinates and the lower right coordinates of the first vehicle area to the template creation section 13, after having finished the search of the search area.

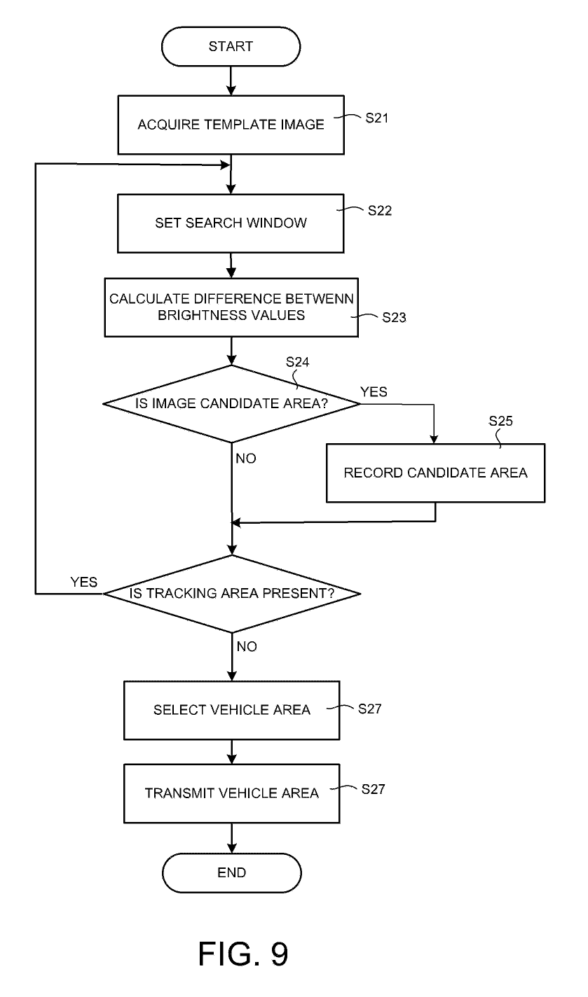

Next, an operation example in which the vehicle tracking section 40 extracts a second vehicle area will be described with reference to FIG. 9. FIG. 9 is a flow chart for explaining an operation example in which the vehicle tracking section 40 extracts a second vehicle area.

To begin with, the template reading section 41 of the vehicle tracking section 40 acquires the template image which the template storage section 14 stores (step S21).

When the template reading section 41 acquires the template image, the second search window setting section 42a of the matching processing section 42 sets a second search window in a tracking area (step S22). The second search window setting section 42a sets the second search window so that raster scan can be executed. That is, when firstly setting a second search window, the second search window setting section 42a sets a second search window at the upper left portion of the second search window. When setting a second search window at second and subsequent times, the second search window setting section 42a moves the second search window as FIG. 2 shows.

When the second search window setting section 42a sets the second search window, the candidate area determination section 42b calculates the difference between a brightness value of each dot in the second search window and a brightness value of each dot of the template image, and calculates a sum total value of the differences (step S23). Having calculated the sum total value, the candidate area determination section 42b determines whether the image in the second search window is a candidate area based on the sum total value (step S24).

When the candidate determination section 42b determines that the image in the second search window is the candidate area (step S24, YES), the matching processing section 42 records the determined candidate area (step S25)

When the candidate determination section 42b determines that the image in the second search window is not the candidate area (step S24, NO), or when the matching processing section 42 has recorded the candidate area (step S25), the matching processing section 42 determines whether the tracking area where the second search window has not been set is present (step S26).

When the matching processing section 42 determines that the tracking area where the second search window has not been set is present (step S26, YES), the matching processing section 42 returns the operation to the step S22.

When the matching processing section 42 determines that the tracking area where the second search window has not been set is not present (step S26, NO), the vehicle area selection section 43 selects a second vehicle area from the candidate area (step S27). When the vehicle area selection section 43 selects the second vehicle area, the vehicle tracking section 40 transmits the selected second vehicle area to the template update section 50.

When the vehicle tracking section 40 transmits the selected second vehicle area to the template update section 50, the vehicle tracking section 40 finishes the operation. The vehicle tracking section 40 performs the same operation to each tracking area which the tracking area setting section 15 has set.

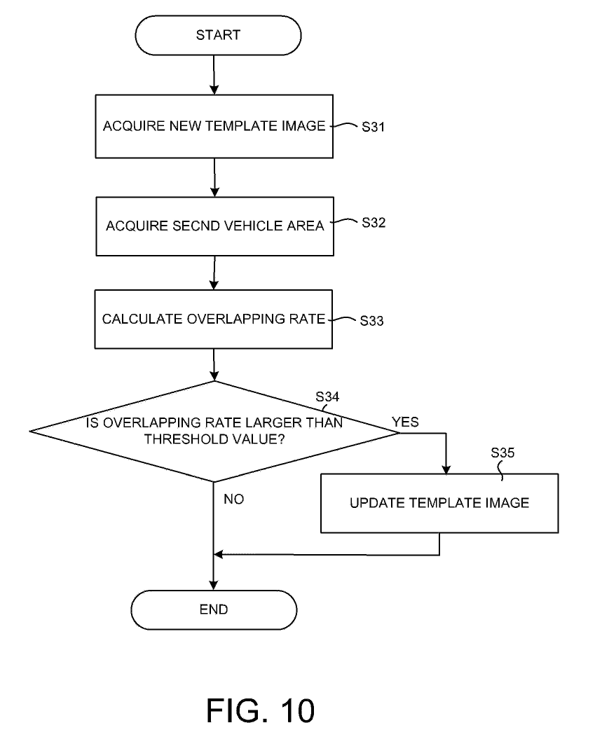

Next, an operation example of the template update section 50 will be described with reference to FIG. 10. FIG. 10 is a flow chart for explaining an operation example of the template update section 50.

To begin with, the template update section 50 acquires the new template image which the template creation section has created (step S31). The new template image is a template image which is generated after the template image which the vehicle tracking section 40 has used for extracting the second vehicle area.

When the template update section 50 acquires the new template image, the template update section 50 acquires the second vehicle area which the vehicle tracking section 40 has extracted (step S32). When the template update section acquires the second vehicle area, the overlapping rate calculation section 51 calculates an overlapping rate between the second vehicle area and the new template image (step S33).

When the overlapping rate calculation section 51 calculates the overlapping rate, the template update determination section 52 determines whether to update the template image based on the overlapping rate (step S34). That is, the overlapping rate calculation section 51 calculates the difference between a brightness value of each dot of the new template image and a brightness value of each dot of the second vehicle area, and calculates a sum total value by summing the all differences between the brightness values of the respective dots. When the sum total value is not more than a prescribed threshold value, the template update determination section 52 determines that the new template image and the second vehicle area coincide with each other, and determines that the template image stored in the template storage section 14 is to be updated by the new template image.

When the template update determination section 52 determines to update the template image (step S34, YES), the template image update section 50 updates the template image (step S35). That is, the template update section 50 rewrites the template image stored in the template storage section 14 by the new template image. In addition, the template update section 50 rewrites the information indicating the upper left coordinates and the lower right coordinates of the template image by the information indicating the upper left coordinates and the lower right coordinates of the new template image. That is, when the template update determination section 52 determines that the new template image and the second vehicle area coincide with each other, the template update section 50 updates the template image stored in the template storage section 14 by the new template image.

When the template update determination section 52 determines not to update the template image (step S34, NO), or when the template update section 50 has updated the template image (step S35), the template update section 50 finishes the operation. In addition, the order of the step S31 and the step S32 may be a reverse order.

In addition, when the vehicle detection section 20 cannot extract a first vehicle area in the second vehicle area which the vehicle tracking section 40 has extracted, the vehicle discrimination apparatus 1 may transmit the image of the second vehicle area to the discriminator construction section 30. In this case, the discriminator construction section 30 may make the discriminator 26 perform learning using the transmitted second vehicle area.

In addition, the vehicle discrimination apparatus 1 may change the likelihood threshold value and the brightness value threshold value in accordance with road environment, such as a time zone and the weather. In addition, in the determination of presence/absence of vehicle, the vehicle discrimination apparatus 1 may determine which of the first vehicle area and the second vehicle area is to be emphasized in accordance with the road environment.

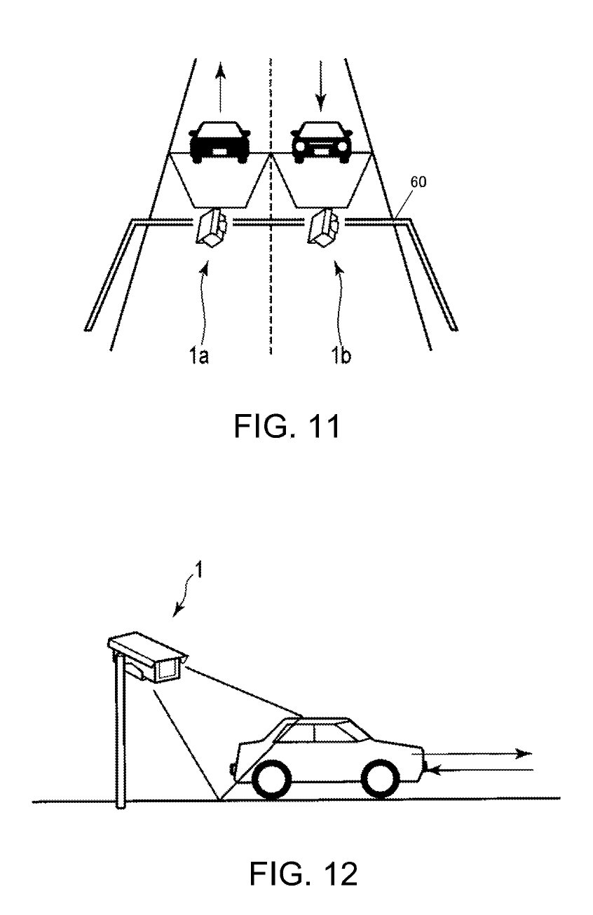

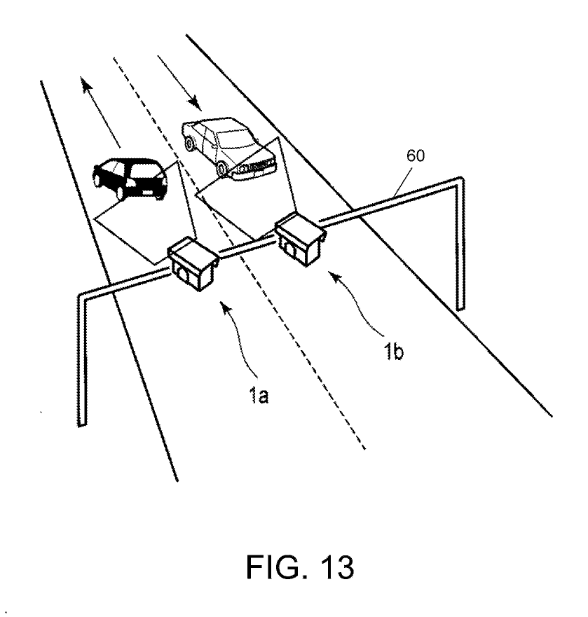

Next, a free flow toll fare collection apparatus which is provided with the vehicle discrimination apparatus 1 according to the embodiment will be described. FIG. 11 is a top view of an example of a free flow toll fare collection apparatus in which the vehicle discrimination apparatus 1 is installed. FIG. 12 is a side view of the example of the free flow toll fare collection apparatus in which the vehicle discrimination apparatus 1 is installed. FIG. 13 is a perspective view of the example of the free flow toll fare collection apparatus in which the vehicle discrimination apparatus 1 is installed.

As FIG. 11, FIG. 12 and FIG. 13 show, the free flow toll fare collection apparatus is provided with a vehicle discrimination apparatus 1a and a vehicle discrimination apparatus 1b respectively for an up traffic lane and a down traffic lane. The vehicle discrimination apparatuses 1a and 1b respectively detect vehicles passing through the up traffic lane and the down traffic lane.

The free flow toll fare collection apparatus is provided with cameras installed on a gantry 60 or the like above a road as the photographing devices. The free flow toll fare collection apparatus may extract a frame image candidate in which a vehicle is photographed, using a processing with a relatively low processing cost, such as background difference and inter-frame difference, and may perform the processing which the vehicle detection section 20 performs to the frame image candidate. In this case, the vehicle discrimination apparatus 1 may extract a vehicle or a local portion from which the vehicle can be specified, such as a number plate. For example, the vehicle discrimination apparatus 1 may use a feature amount of the whole vehicle, or may use a feature amount of a local portion from which the vehicle can be specified, such as a number plate.

In the vehicle discrimination apparatus configured as described above, the vehicle tracking section extracts the vehicle area in the periphery of the vehicle area which the vehicle detection section has extracted. As a result, the vehicle discrimination apparatus can limit a range where the vehicle area is searched, and can effectively discriminate a vehicle.

In addition, the function described in the above-described embodiment may be configured using hardware, or may be realized using a CPU and software which is executed by the CPU.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A vehicle discrimination apparatus, comprising:
an image acquisition section to acquire an image;
a first search window setting section to set a first search window in the image;
a feature amount calculation section to calculate a feature amount of the image in the first search window;
a likelihood calculation section which calculates a likelihood indicating a possibility that the image in the first search window is a first vehicle area including a vehicle image, based on the feature amount;
a vehicle area determination section to determine whether the image in the first search window is the first vehicle area, based on the likelihood;
a template creation section to generate a template image based on the first vehicle area;
a template storage section to store the template image;
a tracking area setting section which sets a tracking area based on the template image;
a second search window setting section to set a second search window in the tracking area;
a candidate area determination section to determine whether an image in the second search window is a candidate area that is an area to coincide with the template image;
a selection section which selects a second vehicle area including the vehicle which the template image indicates from the candidate area; and
a detection section to detect at least presence/absence of the vehicle based on the first vehicle area and the second vehicle area.

2. The vehicle discrimination apparatus according to claim 1, wherein:
the tracking area setting section sets the tracking area in an area which the template image indicates and its periphery.

3. The vehicle discrimination apparatus according to claim 1, wherein:
the second search window setting section determines a size of the second search window based on the template image.

4. The vehicle discrimination apparatus according to claim 1, wherein:
the candidate area determination section calculates a difference between a brightness value of each dot of the image in the second search window and a brightness value of each dot of the template image, calculates a sum total value obtained by summing all the differences between the brightness values of the respective dots, and determines that the image in the second search window is the candidate area when the sum total value is not more than a prescribed threshold value.

5. The vehicle discrimination apparatus according to claim 1, wherein:
when the candidate image is one, the selection section selects the candidate image as the second vehicle area, and when a plurality of the candidate images are present, the selection section selects the one candidate image from a plurality of the candidate images, based on a positon of the past first vehicle area or the past second vehicle area from the candidate image, as the second vehicle area.

6. The vehicle discrimination apparatus according to claim 1, further comprising:
a template update section which, when a new template image which the template creation section has newly created coincides with the second vehicle area, updates the template image which the template storage section stores by the new template image.

7. The vehicle discrimination apparatus according to claim 6, wherein:
the template update section calculates a difference between a brightness value of each dot of the new template image and a brightness value of each dot of the second vehicle area, calculates a sum total value obtained by summing all the differences between the brightness values of the respective dots, and determines that the new template image and the second vehicle area coincide with each other, when the sum total value is not more than a prescribed threshold value.

8. The vehicle discrimination apparatus according to claim 1, wherein:
the template creation section receives information indicating the first vehicle area from the vehicle area determination section for each several images.

9. The vehicle discrimination apparatus according to claim 1, wherein:
the first search window setting section sets the first search window in an image area where an vehicle can exist in the image.

10. The vehicle discrimination apparatus according to claim 1, wherein:
the first search window setting section sets a size of the first search window based on a distance between an object photographed in the image and a photographing device which has photographed the image.

11. The vehicle discrimination apparatus according to claim 1, further comprising:
a search area setting section which sets an image area where the vehicle can exist in the image as a search area.

12. The vehicle discrimination apparatus according to claim 11, wherein:
the search area setting section varies a size of the first search window in the search area.
